(19) United States
(12) Patent Application Publication
(10) Pub. No.: US 2010/0218078 A1
(43) Pub. Date: Aug. 26, 2010

(54) GRAPHICAL USER INTERFACE (GUI) FOR SCIENTIFIC REFERENCE COMPRISING A THREE-DIMENTIONAL, MULTI-FRAMED UNIFICATION OF CONCEPT PRESENTATIONS

(76) Inventor: Martin Gerard Channon, Laurel, MD (US)

Correspondence Address: Martin Channon, 14525 SW Millikan Way, Beaverton, OR, 97005, US

(21) Appl. No.: 12/733,237

(22) PCT Filed: Aug. 28, 2008
(86) PCT No.: PCT/US2008/010190

§ 371 Date: Feb. 17, 2010

Related U.S. Application Data
(60) Provisional application No. 60/966,424, filed on Aug. 28, 2007.

(51) Int. Cl. G06F 3/048; G06F 3/14

(52) U.S. Cl. 715/205; 715/771

(57) ABSTRACT

A three-dimensional scientific reference software program for generating a graphical user interface is disclosed. The interface includes a categorical listing of primary science and humanities disciplines/sub-disciplines providing a hyperlink to detailed information, and a categorical listing of cosmological phenomena corresponding to the primary science and humanities disciplines/sub-disciplines. Including the foregoing categorical text listings, a 3D unified schematic is displayed representing the cosmos as a whole, including a composite of multiple individual diagrams representing a cosmological phenomena and plotted within a graphical time/space coordinate system. Anyone of the individual diagrams may be displayed in enlarged isolated format, and the user can drill down to obtain more detailed information on anyone of said phenomena. Controls are provided for manipulating the unified schematic in three-dimensional space. The scientific reference software serves as a 3D graphics-based summation of science and humanities concepts for expedient reference.

### BACKGROUND OF THE INVENTION

1. Technical Field

The invention relates to scientific reference tools and materials to help optimize the ability to retrieve scientific information. More particularly, the invention relates to scientific reference software including a graphical user interface (GUI) comprising a three-dimensional, multi-framed unification of scientific concept presentations (including civil, life, physical, biological, and astronomical sciences) to provide expedient access to detailed content and to highlight relationships heretofore unseen.

2. Background Art

Maps are used in many fields of endeavor to depict physical relationships. In this regard a map's visualization techniques are as important as its information content. When data is graphically presented using appropriate visualization techniques, it can accetuate key relationships, and stimulate discovery.

Computers rely on maps called graphical user interfaces (GUI) which have become firmly established as the preferred user interface. The traditional desktop GUI is two-dimensional: the visual elements lie in the xy plane. Thus, where visual elements overlap they obscure each other. In a 3D GUI the visual elements are situated in xyz space, are defined in terms of 3D coordinates, need not be flat and may contain spatial regions (volumes).

A three-dimensional mapping or interface usually communicates information more effectively than two-dimensional. For example, United States Patent Application 20070157126 by Tschirhart et al. published Jul. 5, 2007 shows a three-dimensional interface for controlling a plurality of electronic appliances. However, the design considerations for a 3D GUI are more complex than for a 2D GUI. The transition from 2D to a dynamic 3D world requires a more complex software architecture: a 3D Graphics Engine that inputs a 3D graphics file and renders a 3D image. Currently, these 3D graphics files may be written in any of a variety of programming languages. For example, virtual reality modeling language (VRML) was developed for this purpose, and XML (Extensible Markup Language) is now emerging as the most likely successor. In addition, Java and ActiveX are languages used to create three-dimensional objects. The foregoing and other like languages make 3D reference software possible that provides quicker access to information and more effective visualization techniques, accetuating key relationships, and stimulating discovery.

There are many examples of scientific reference software. Unfortunately, each software program to date has tended to devote itself to one particular branch of science, and is constrained to a simple 2D “table-of-contents-like” user interface. This is not the most effective visualization technique, and it utterly fails to show any relationships between the various scientific branches.

The present inventor has developed a three-dimensional mapping software method suitable for use as an overarching scientific reference that maps all scientific and technical aspects of our universe to a 3D coordinate system. The software serves as a useful source for data, concepts and graphical illustrations of most all phenomena, and is helpful to professionals in the sciences, students and anyone who would otherwise use a scientific reference or encyclopedia.

### DISCLOSURE OF INVENTION

It is a primary object of this invention to provide a graphical user interface (GUI) for scientific reference comprising a three-dimensional, multi-framed unification of scientific concept presentations. The term concept presentations as used herein includes schematics, graphs, formulae, tables, diagrams and other means of summarizing and presenting scientific information and concepts. The appropriateness of such concept presentations will vary according to the type of information to be conveyed and the depth or amount of detail provided.

It is another object to provide an improved three-dimensional interactive unified map of the sciences (including civil, life, physical, biological, and astronomical sciences) with more expedient access to detailed content.

It is another object to provide a three-dimensional map of all science and humanities concepts for our cosmos into a single 3D time/space coordinate system.

It is still another object to provide a three-dimensional unification of concept presentations in such a manner as to present, overall, the appearance of a cliché or symbol for an abstract work of art. This may take the form of a flower in a vase on a pedestal all within a frame with lettering, title and signature (a still life). Alternatively, it might present the appearance of a tree on a plane all within a frame, with lettering, title and signature (a landscape). As yet another alternative, it may take the form of a lamp on a table, all within a frame, with lettering, title and signature (another still life).

It is still another object to provide a fully articulating (pan, tilt, zoom, rotate) interactive 3D reference schematic as a navigable user-interface gateway to more detailed information on scientific data, concepts and graphical illustrations of most all phenomena, more helpful to scientists, students and anyone who would otherwise use a scientific reference or encyclopedia.

In accordance with the foregoing and other objects, the present invention is a three-dimensional scientific reference software program for generating a graphical user-interface intended to provide expedient access to detailed content and highlight global relationships. The user-interface appears as a user-navigable 3D unified schematic representing the cosmos as a whole. The interface generally includes a three-dimensional time/space coordinate system, a text listing of primary science and humanities disciplines, a text listing of primary phenomena (each corresponding to a science/humanities discipline), a composite plot of schematics for the various listed phenomena appearing within the coordinate system (all standard schematics for physical, biological and civil sciences), and a detailed viewer pane.

The plot is a composite of multiple individual diagrams each representing one of the phenomena plotted within the graphical time/space coordinate system. By navigating between the text listing of primary phenomena, the viewer pane, and the composite plot, the user can drill down to obtain more detailed information on any one of said phenomena.

More specifically, the list of phenomena 6 comprises a categorization of the thirty primary forms of phenomena studied in the various intellectual disciplines, appearing on the right-hand side of the schematic, and each being a hyperlink that loads classification tables (e.g., the periodic table) into a far-right viewer frame. The classification tables likewise include hyperlinks that act back on the unified schematic, singling out individual schematics (e.g., clicking the Hydrogen entry H in the periodic table engenders a cross-section for hydrogen 1s state to a face-on view). Further, links in the classification tables act on the right viewer frame, loading supplemental diagrams (e.g., the hydrogen energy level diagram). Links in these supplemental diagrams also act back on the unified schematic, loading more detailed diagrams and information.

On the left of the unified schematic, the interface includes a categorical listing of disciplines that correspond to the phenomena listed on the right (sciences and humanities). These are also hyperlinks that load breakdowns of the disciplines (subdisciplines) to the right-side frame. The subdisciplines are broken down into topic areas and these into condensations of concepts (e.g., lists of physics formulary) with explanatory material available via additional hyperlinks. In addition, a plurality of controls are provided for manipulating the unified schematic in three-dimensional space. The scientific reference software serves as a 3D graphics-based summation of scientific concepts for expedient reference.

### BRIEF DESCRIPTION OF DRAWINGS

Other objects, features, and advantages of the present invention will become more apparent from the following detailed description of the preferred embodiments and certain modifications thereof when taken together with the accompanying drawings in which:

FIG. 1 is a screen print of the main user interface of the present invention.

FIG. 2 is a screen print of a portion of the main user interface with the cursor positioned over “The Atom” cosmological phenomena 4 entry at right (as counted up from “Elemenatary Particles).

FIG. 3 is a screen print of the main user interface after clicking on “The Atom”.

FIG. 4 is a screen print of the main user interface after clicking on H for Hydrogen in the viewer pane of FIG. 3, which shows the enlarged and rotated cross-sectional schematic for the Hydrogen 1s state from the composite plot 2 of FIG. 1 to a full frame frontal view 16.

FIG. 5 is a screen print of the main user interface after clicking on the hyperlink for the hydrogen 2p state in the viewer pane 10 of FIG. 4 and then clicking on the hyperlink m=0 in the viewer pane 10 of FIG. 4, which shows a diagram 20 of the hydrogen 2p state (m=0) and repopulated viewer pane 10 by zooming in on the 2p fine structure and loading the comments section 12.

FIG. 6 is another example attained by clicking on the hyperlink for the Hydrogen 4f state in the viewer pane 10 of FIG. 4, and then clicking on the hyperlink m=0 in the viewer pane 10 of FIG. 4, which populates the left frame with diagram 30 for the Hydrogen 4f state (m=0).

FIG. 7 is a screen shot of the isolated view of the Civilization curves.

FIG. 8 is a screen shot of the isolated view of the Biosphere curves.

FIG. 9 is a screen shot of the isolated view of the Metacluster map.

FIG. 10 is a plot of event number vs. event time for the primary cosmological events.

### BEST MODE FOR CARRYING OUT THE INVENTION

The present invention is a three-dimensional mapping software method, suitable for use as a scientific reference, that maps scientific and technical aspects of the known cosmos into a 3D time/space coordinate system. This software serves as a science-related reference tool: one that takes the form of a graphics-based summation of concepts. It is a useful source for data, concepts and graphical illustrations of most all phenomena, and is helpful to scientists, students and anyone who would otherwise use a scientific reference or encyclopedia.

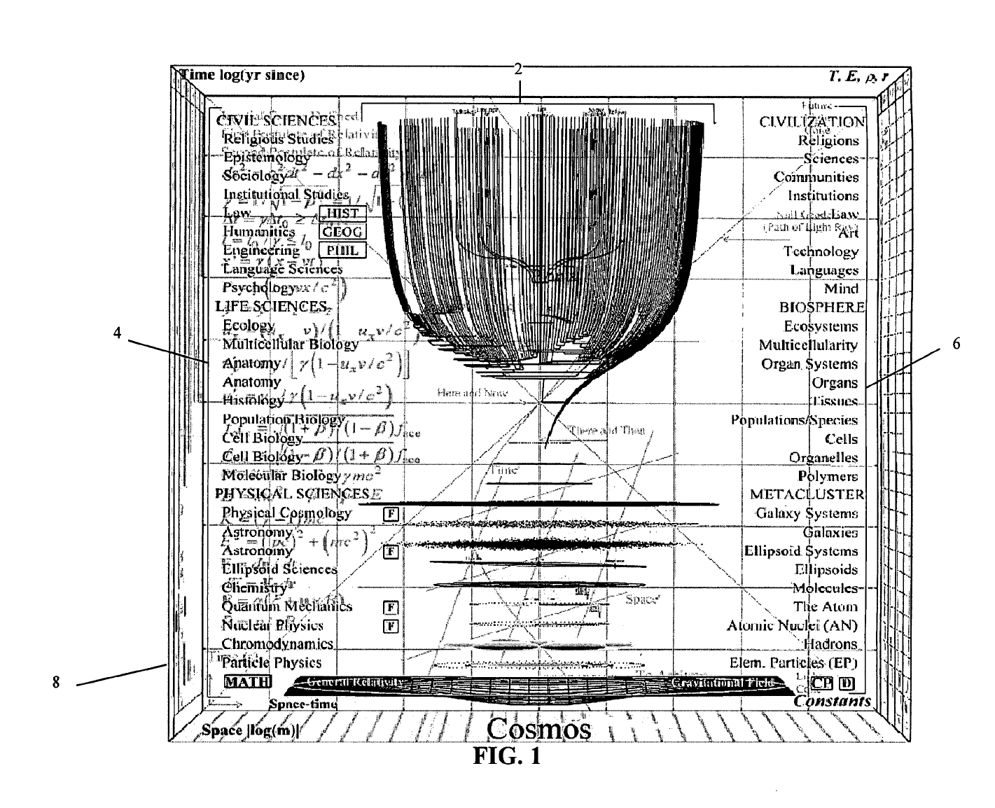

FIG. 1 is a screen print of the main user interface of the present invention, which appears as a user-navigable unified schematic for the cosmos as a whole, rendered by arranging within a time/space coordinate system the standard schematics for all particle, biological and civil science phenomena. The interface allows the user to drill down through levels of data to obtain detailed information much more quickly.

More specifically, the interface includes a three-dimensional time/space coordinate system 8 (designated by a bounding 3D box), a text listing of primary scientific and humanities disciplines 4 (at left inside the box), a text listing of primary phenomena 6 (at right inside the box), and a composite plot of schematics for the various phenomena 2 (center).

The phenomena listing 6 generally comprises a list of primary categories of phenomena studied in the various intellectual (science and humanities) disciplines. The discipline listing 4 comprises a list of the disciplines corresponding to the phenomena in listing 6. Thus, the categorical listing 4 of primary science and humanities disciplines at left corresponds to the phenomena listing 6 on the right side.

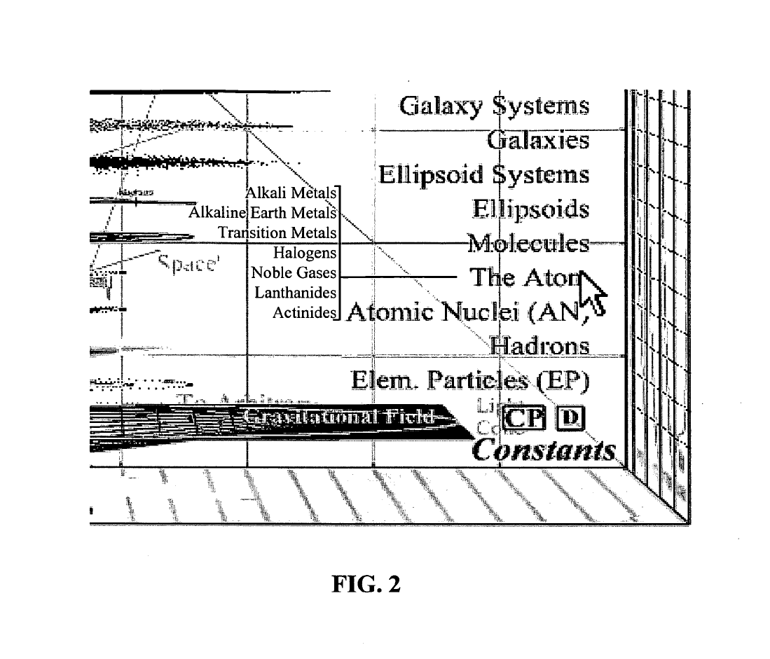

In the illustrated embodiment the phenomena listing 6 includes a list of the thirty primary categories of phenomena studied in the various intellectual (science and humanities) disciplines. Each entry is referenced in the listing of primary scientific/humanities disciplines 4 in the left frame. The categorical discipline listing 4 also comprises a series of hyperlinks that load breakdowns of the disciplines (subdisciplines) into the right-side viewer frame 10 (as seen in FIG. 2. The subdisciplines are broken down into topic areas and these into condensations of concepts (e.g., lists of physics formulary) with explanatory material available via additional hyperlinks. The illustrated primary science and humanities disciplines 4 are currently categorized into three (3) scientific headings including: 1) CIVIL SCIENCES; 2) LIFE SCIENCES; 3) PHYSICAL SCIENCES.

These primary scientific discipline are listed in text form in a column to the left of the composite plot schematic 2, along with each of their corresponding subdisciplines as follows:

1) Civil Sciences
religious studies, epistemology, social sciences, institutional studies, law, humanities, engineering, language sciences, psychology.

2) Life Sciences
ecology, multicellular biology, anatomy, histology, population biology, cell biology, molecular biology.

3) Physical Sciences
physical cosmology, astronomy, ellipsoid sciences, chemistry, quantum mechanics, nuclear physics, chromodynamics, particle physics.

Each primary science and humanities discipline 4 is a hyperlink that, when clicked, loads an information window into the viewer pane 10 (to the right) that offers a breakdown of the discipline into sub-disciplines. The sub-disciplines may be broken down further into topics and finally summations of concepts (with optional explanatory comments, for example, a hyperlink to third party reference material on the subdiscipline may be provided).

Currently, certain science and humanities subdisciplines remain unclassified. For example, next to the CIVIL SCIENCES there appear the boxes, GEOG, PHIL, and HIST. These are subdisciplines that will eventually be included under proper primary science and humanities disciplines but as yet remain uncategorized. Nevertheless, the uncategorized subdisciplines (GEOG, PHIL, HIST) are also hyperlinks that, when clicked, load an information window into the viewer pane 10 (to the right) that may be broken down further into topics and finally summations of concepts (with optional explanatory comments. For example, clicking on GEOG will display an index on the subject in the right display pane, inclusive of the following subtopics: Cartography; Human geography; Cultural geography; Feminist geography; Economic geography; Development geography; Historical geography; Time geography; Political geography & geopolitics; Military geography; Strategic geography; Population geography; Social geography; Behavioral geography; Children's geographies; Health geography; Tourism geography; Urban geography; Environmental geography; Physical geography; Biogeography; Climatology; Palaeoclimatology; Coastal geography; Geomorphology; Geodesy; Hydrology/Hydrograph; Glaciology; Limnology; Oceanography; Landscape ecology; Palaeogeography; Regional Geography. All of these sub-disciplines are hyperlinked to more exhaustive information.

Referring back to the central part of the schematic, the plot of schematics for various phenomena 2 comprises a three dimensional composite plot with individual schematics (geometric curves) representing, chronologically, the primary phenomena listed in phenomena listing 6 and studied in the various disciplines in listing 4.

The composite plot of schematics 2 (center) consolidates standard schematics for the natural and civil phenomena listed at right and arranges them in a unique manner within the time-space coordinate system 8 to produce a unified schematic for the cosmos as a whole.

The composite plot of schematics 2 (as well as both listings 4, 6) appears in the context of the three-dimensional coordinate system 8 with time on the vertical axis and space on the horizontal. An expanded version of the geologic time scale is represented on the left side, vertical face. This time scale includes geologic increments, and astrophysical and archeological time scales. This is called by clicking on the link, “Time log(yr).” Note that a schematic for Space-time is embedded in the rear face, and the right side face is used to present graphs for the primary cosmological parameters (particle energy, density, temperature and radius. These are brought out via special links “Space-time” and “T, E, p, r”.

The first part of the schematic to develop is the timeline itself. The typical timeline for cosmological events starts at about t=10⁻⁴⁵ and ends at t=10¹⁸ seconds, a future time just past the present. Physical science events are indicated along this timeline. Now, the intent is to produce a similar timeline, but one that also includes life- and civil-science events. As discussed, there are other phenomena legitimately viewed as important aspects of the cosmos. But if we are to include a reference to these other phenomena, a simple logarithmic scale becomes problematic. At the high end, numerous events are bunched together in an unreadable manner, and at the low end, things are spread out more than they need to be. To remedy this, the timeline needs to be adjusted; ideally, the events would be spread out in a uniform manner. To accomplish this the present invention alters the standard logarithmic scale by use of a “scaling equation.”

The start time for the interval is simply t=0, the time for the big bang. The end point is the event time for the fully formed typical civilization (Astrobiologists now generally believe that civilizations are common in the cosmos). This point was determined by starting with the typical event time for star formation (6×10⁹ years after the big bang) and adding the time for the formation of a planetary system and the evolution of life (4.5×10⁹) and the development of civilization. Given that the interval will be measured in terms of billions of years, the brief interval for the development of civilization is negligible. This results in a time interval of approximately 10¹⁰ years.

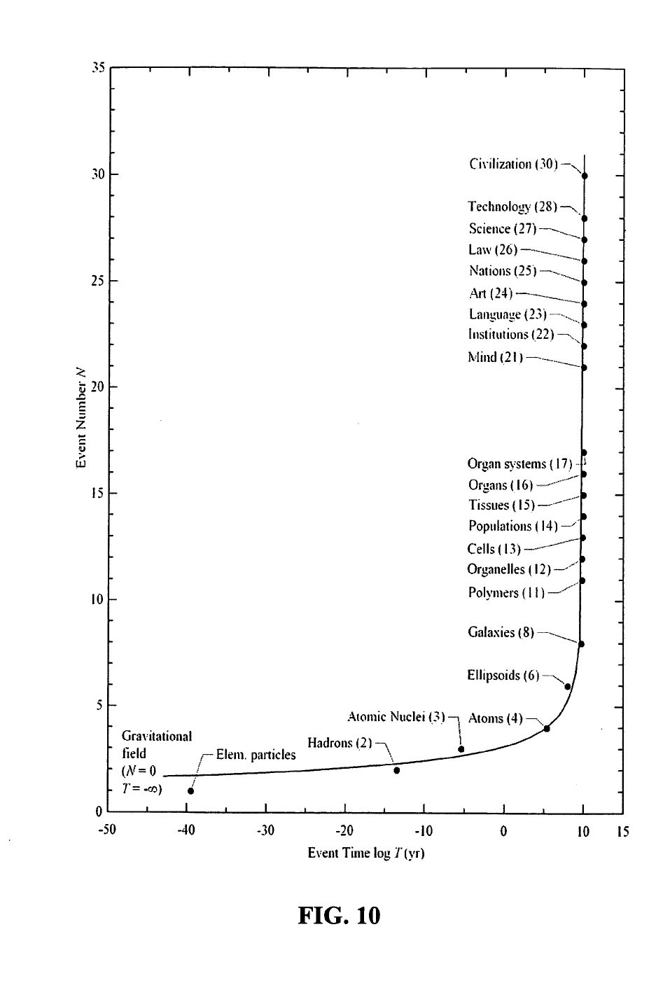

Each event is given an event number, N. For most events we also have known event times in terms of years since the big bang. These can be graphed as depicted in FIG. 10. It is this graph that specifies the scaling equation. This curve, however, is very sensitive at the high end, a minimum of ten significant figures needed to distinguish between the two uppermost points. Getting the proper fit is slightly complicated. This is achieved by first finding a fit for the physical- and life science events and then adding on a corrective term for those of the civil sciences. A good fit for the physical- and life-science events is

N=(8.047×10⁻³−8.029×10⁻⁴T)^{-0.2809}−0.7505

where T is the logarithm for years since the big bang.

When this equation is extended through the civil-science region of the graph, it produces a smoothly increasing error that is well-modeled by the term

N=10.1783 exp [−2554.47(10−T)^{0.484597}]

Combining these two, the scaling equation in terms of years since the big bang would be

N=(8.047×10⁻³−8.029×10⁻⁴T)^{-0.2809}+10.1783 exp [−2554.47(10−T)^{0.484597}]−0.7505

To get a corresponding expression in terms of years ago, we can use the following substitution:

$$T = \frac{ln ( {10}^{10} - {10}^{{T}_{ya}} )}{ln 10}$$

where T_{ya} is the logarithm for years ago. The scaling equation in terms of years ago is then

$$N = {\{ 8.047 \times {10}^{- 3} - 8.029 \times {10}^{- 4} [ \frac{ln ( {10}^{10} - {10}^{{T}_{ya}} )}{ln 10} ] \}}^{- 0.2809} + 10.1783 exp \{ - 2554.47 {( 10 - [ \frac{ln ( {10}^{10} - {10}^{{T}_{ya}} )}{ln 10} ] )}^{0.484597} \} - 0.7505$$

The z-axis (perpendicular to the plane of the computer screen) is a secondary spatial axis. Thus, two-dimensional, Euclidean space is represented by the lower face of the coordinate system 8. This is brought out by clicking on “Space |Log(m)|”. With this schematic called, the user can switch from Euclidean to either spherical or hyperbolic space, in which case the composite plot 2 will be redrawn accordingly. This is achieved by clicking on the buttons for “2D Hyperbolic Space” or “2D Spherical Space.” Clicking on either of these will cause the illustrated Euclidean schematic to morph into these alternative forms.

Within the above-described coordinate system, the composite plot 2 represents standard schematics for all phenomena arranged in the order that the corresponding phenomena have developed over time.

Thus, for example, the embedded diagram for the gravitational field (so labeled) appears at the lowest level, simply because the gravitational field (aside from space and time) was the first phenomenon to develop. All other phenomena 6 (listed at right) will be represented by an appropriately placed diagram in the composite plot 2, thereby forming a unified composite plot 2 of all schematics for the various phenomena.

The entire schematic (and each individual schematic) may be freely manipulated by the user via Plan, Pan, Turn, Roll, GoTo, Align, View, Restore and Fit control buttons across the left side and bottom of the screens. These controls are a function of the VRML plug-in used to display the schematic. Additional controls are provided.

Above the gravitational field are placed cross-sectional diagrams for the various particle phenomena, then the 3D phylogenetic tree, and finally a schematic representation for civilization, another tree-like schematic.

Each of these phenomena is labeled along the right side (“Elementary particles,” “Hadrons,” etc.).

It is important to note that the composite plot FIG. 1 as described above reflects a common artistic theme (flower in a vase on a pedestal, all within a frame, with lettering, title and signature) and visually binds together such concepts.

The composite schematic FIG. 1 is displayed using a conventional VRML client package, for example, Cortona3D™ by ParallelGraphics. Cortona®3D is a fast and highly interactive 3D viewer. The user's browser will accept the Cortona VRML Client which works as a VRML plug-in for popular Internet browsers (Internet Explorer, Netscape Browser, Mozilla, Firefox, etc.) and office applications (Microsoft PowerPoint, Microsoft Word, etc).

The phenomena listing 6 (on the right side of the interface) comprises a list of the thirty primary categories of phenomena studied in the various intellectual (science and humanities) disciplines. Each entry is referenced in the listing of primary scientific/humanities disciplines 4 in the left frame scene, and each phenomena 6 entry is a hyperlink that loads a corresponding classification schematic into a right frame viewer (as will be described). This provides the user with a quick and expedient pathway to more detailed information (as will be described).

Currently, the primary natural phenomena 6 (at right) are categorized under three (3) headings including: CIVILIZATION; BIOSPHERE (includes all life, the soil, oceans and atmosphere); and METACLUSTER (physical cosmos). These three phenomena classifications are listed in text form in a single column, along with each of their corresponding subtopics as follows:

Civilization
religions, sciences, communities, institutions, law, art, technology, languages, mind.

Biosphere
ecosystems, multicellularity, organ systems, organs, tissues, populations, cells, organelles, organic molecules.

Metacluster
galaxy systems, galaxies, ellipsoid systems, ellipsoids, molecules, the atom, atomic nuclei, hadrons, elementary particles.

Each of the above headings corresponds to a plot on the unified schematic (typically a cross sectional schematic, e.g., that of the metacluster). Clicking on any heading loads the corresponding classification schematic to the right frame viewer 10, and also brings up supplemental information within the unified schematic as a mouse-over effect (e.g., the time scale). These actions are described in more detail below.

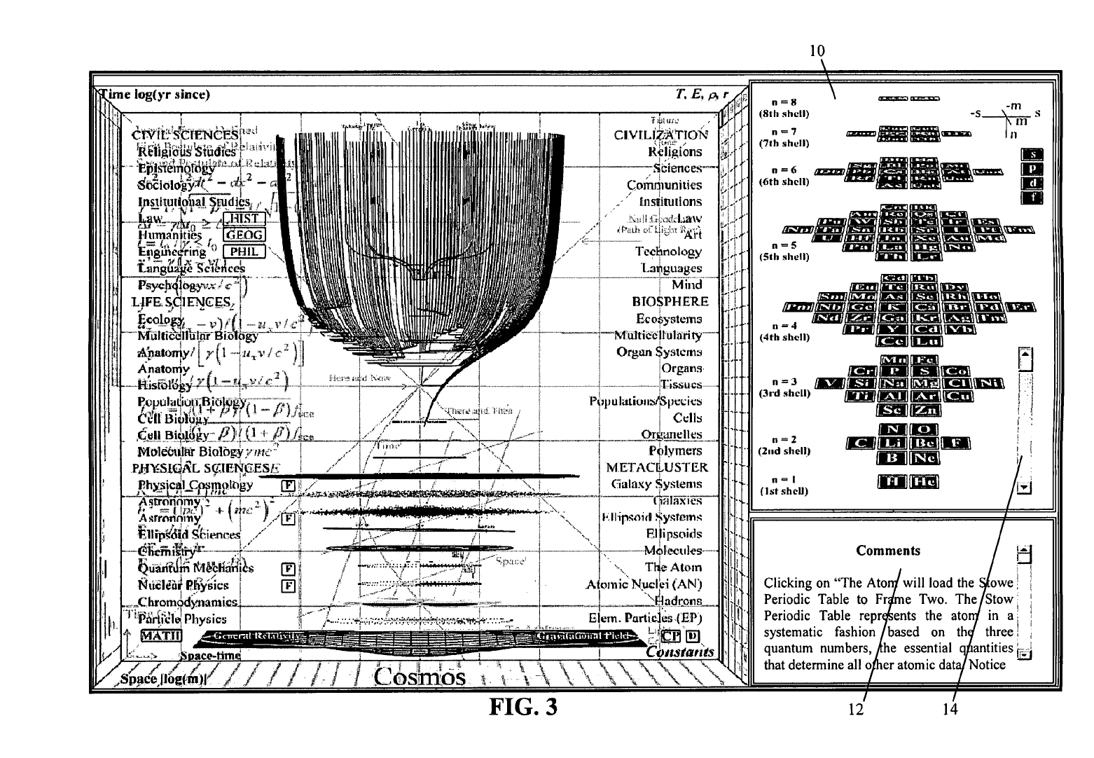

FIG. 2 is a screen print of the main user interface with the cursor positioned over “The Atom”, and FIG. 3 is a screen print after clicking on “The Atom”. Positioning the cursor over “The Atom” engenders a mouse over effect comprising a categorical list of element types (Alkali Metals, Alkaline Earth Metals, Transition Metals, Halogens, Nobel Gases, Lanthanides, Actinides). Moreover, positioning the cursor over “The Atom” or any other phenomena 6 entry at right causes the time and space scales to appear with blinking indicators for the logarithmic measurements corresponding to whichever category the cursor has identified. E.g., positioning the cursor over “The Atom” will bring out the time scale (along the left edge of the unified schematic) with the number “4” blinking, since the event time for atoms was 10′4 years after the big bang. It will also bring out a spatial scale along the lower edge with a blinking line corresponding to 10̂10 meters, the typical atomic radius. These mouse over effects are common throughout the main user interface.

Actually clicking “The Atom” in FIG. 1 or 2 loads the Stowe (Physicist's) Periodic Table (a known alternative the “modern” periodic table) to the right frame viewer 10 as seen in FIG. 3. The Stowe table is inherently three-dimensional and requires interactivity; the levels need to be rotated to get a good look at rearward elements. Buttons in the Stowe table will call schematics for atomic ground states to the left frame and simultaneously call energy level diagrams to the right frame. Buttons in the energy level diagrams call schematics for atomic excited states to the left frame. These may be freely manipulated by the user via Plan, Pan, Turn, Roll, GoTo, Align, View, Restore and Fit control buttons across the left side and bottom of the right frame viewer 10 screen. These controls are a function of the VRML plug-in used to display the schematic.

Every classification table loaded into the viewer panel 10 likewise provides controls for manipulation, and text shapes in the classification table are hyperlinks back to the corresponding individual plots within the composite plot of schematics 2 (in the left pane). Thus, clicking on an hyperlink in the classification schematic will enlarge and rotate the corresponding individual plot within the composite plot of schematics 2 (in the left pane) to a full frontal view for more detailed inspection. For example, the Stowe Table includes hyperlinks that act back on the unified schematic 2, loading schematics for atomic ground states to the left frame. Clicking on these hyperlinks will also load more detailed classification tables to the right frame, e.g., the atomic energy level diagrams.

Links in these supplemental classification tables likewise act back on the unified schematic 2, loading, for example, schematics for atomic excited states to the left frame. This visual side-to-side hyperlinking ensures expedient (“drill-down”) access to detailed information.

The foregoing will be described by way of a detailed example. Actually clicking on “The Atom” in FIG. 1 or 2 loads the Stowe Periodic Table as shown in FIG. 3, with the elements arranged in tiers sorted by shell number (n). This arrangement reflects the periodic recurrence of similar properties as atomic weight increases. Controls are provided as necessary for manipulating the classification table loaded into the viewer pane 10, and for this a slider control 14 is provided as shown for rotation of the Table.

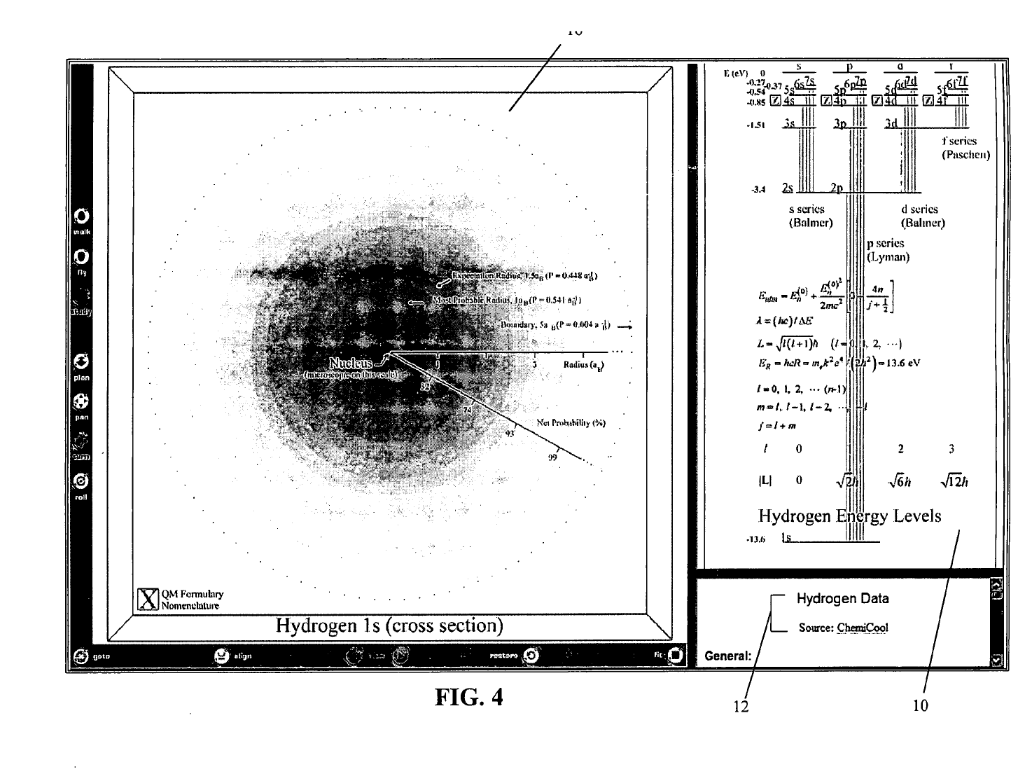

Each elemental entry in the Periodic Table show in FIG. 3 is a hyperlink that can be used to call the corresponding cross-sectional schematic from the composite plot 2 to the left (the atomic elements appear as disc-like plots on the left). Thus, clicking on the Hydrogen entry (H) in the viewer pane 10 of FIG. 3 enlarges and rotates the Hydrogen cross-sectional schematic from the composite plot 2 to a full frame frontal view 16, as seen in FIG. 4. The related equations for atomic orbitals are also provided.

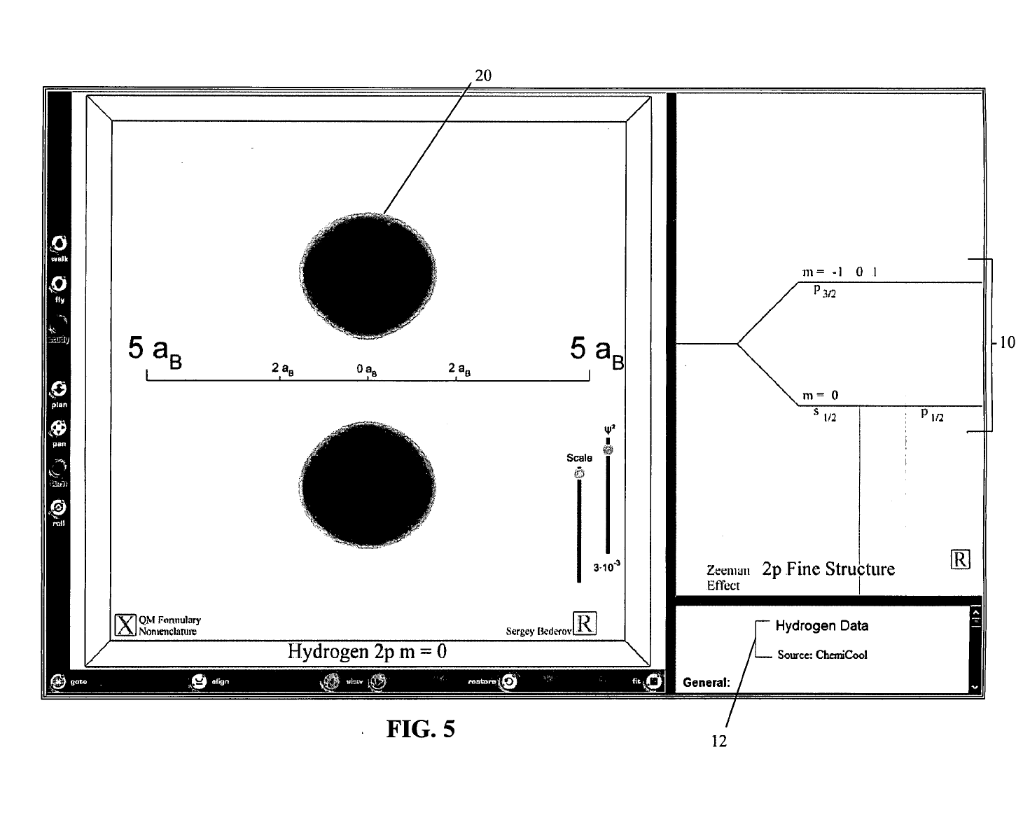

These same buttons (hyperlinks) in FIG. 4 will, simultaneously, repopulate the viewer pane 12 at right with atomic data (e.g., atomic mass, electron configuration) which will load to the display frame 12 (either a smaller sub-frame or pop up window) as seen in FIG. 5. The display frame 12 is likewise repopulated with more detailed explanatory information and/or hyperlinks to relevant data.

Simultaneously upon clicking an elemental entry in the Periodic Table of FIG. 3, the viewer pane 10 of FIG. 3 is repopulated with yet another more detailed classification table. Thus, upon clicking the Hydrogen entry in the Periodic Table of FIG. 3, the Periodic Table in the viewer pane 10 of FIG. 3 will be replaced with the Hydrogen energy level diagram as seen in the viewer pane 10 of FIG. 4.

Clicking on “2p” in the viewer pane 10 of FIG. 4 will cause the energy level diagram to zoom in on the 2p fine structure, 10 of FIG. 5. Buttons there (e.g., m=−1, 0, 1) are again hyperlinks that will cause more schematics for excited states to be loaded to the left frame.

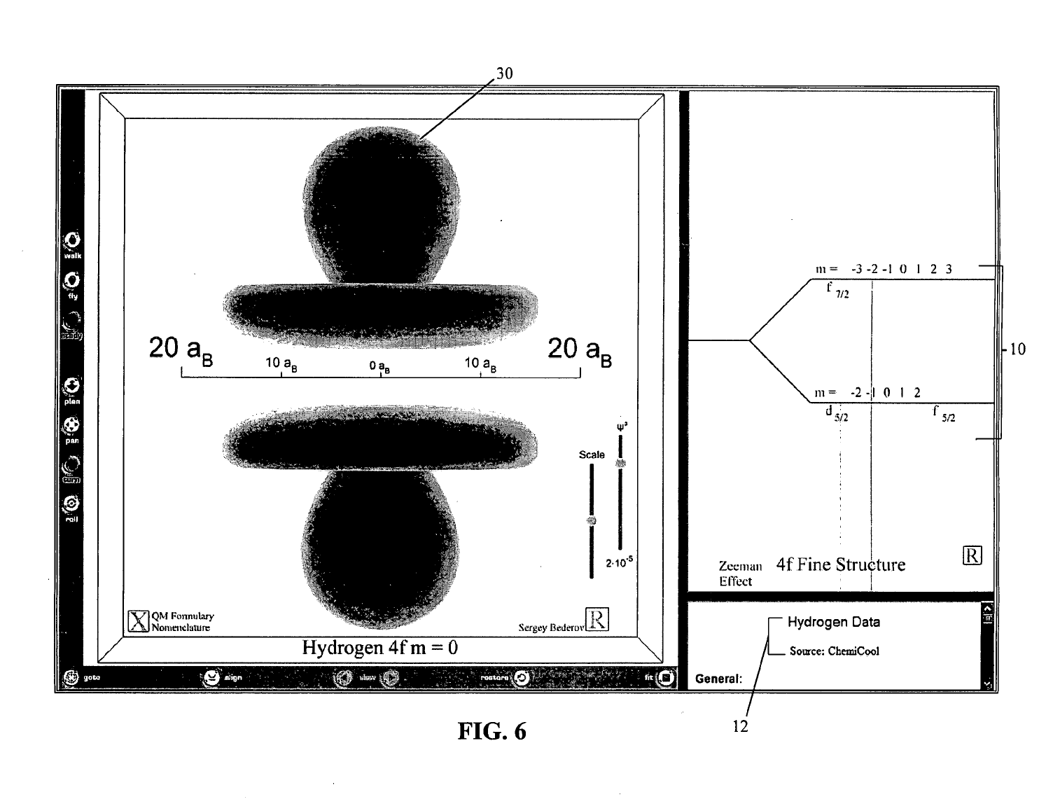

FIG. 6 is another example attained by clicking on “4f” in the energy level diagram. This will cause the energy level diagram to zoom in on the 4f fine structure, 10 of FIG. 6. Buttons there (e.g., m=−2, −1, 0, 1, 2) are again hyperlinks that will cause more schematics for excited states to be loaded to the left frame.

The above-described navigation method as employed by the software should now be self-evident. Text shapes on the left call classification tables to the right, and text shapes therein act back on the unified schematic 2. This left-to-right-and-back drilling down is a unique feature of the invention, as is the use of the Periodic Table to bring up schematics for atomic elements.

Referring back to the three cosmological phenomena classifications 6 listed to the right of the composite plot 2, along with each of their corresponding subtopics, clicking on the CIVILIZATION link at 6 gives an overhead isolated view of the Civilization tree in the composite plot 2 of FIG. 1, inclusive of individual curves for—religions, sciences, communities, institutions, law, art, technology, languages, as well as the circular schematic for mind.

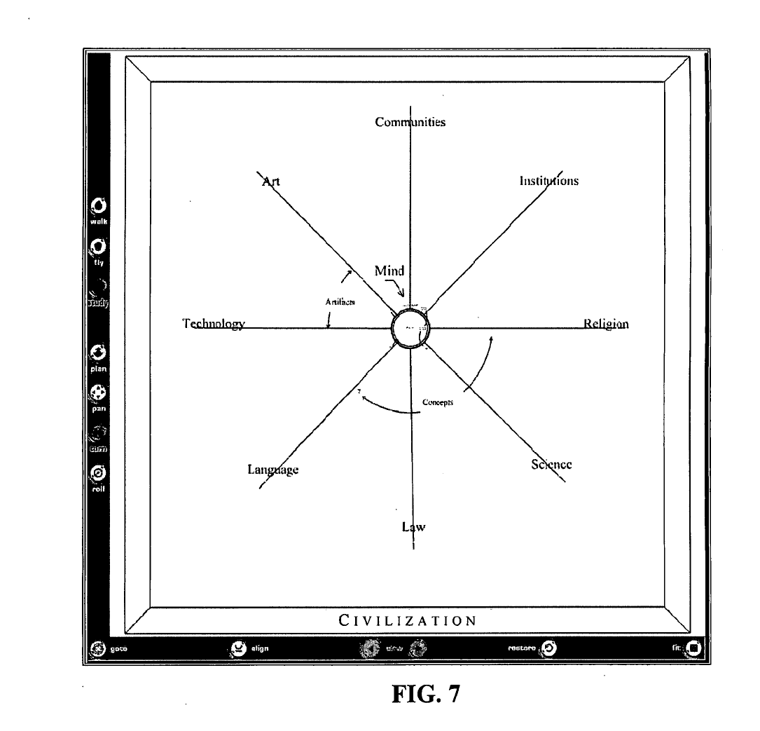

FIG. 7 is a screen shot of the overhead isolated view of the Civilization schematic. Again, this schematic may be freely manipulated by the user via the control buttons across the left side and bottom of the screen.

The same is true for the BIOSPHERE schematic. Clicking on the BIOSPHERE link at 6 (FIG. 1) gives an overhead isolated view of the Biosphere tree in the composite plot 2 of FIG. 1.

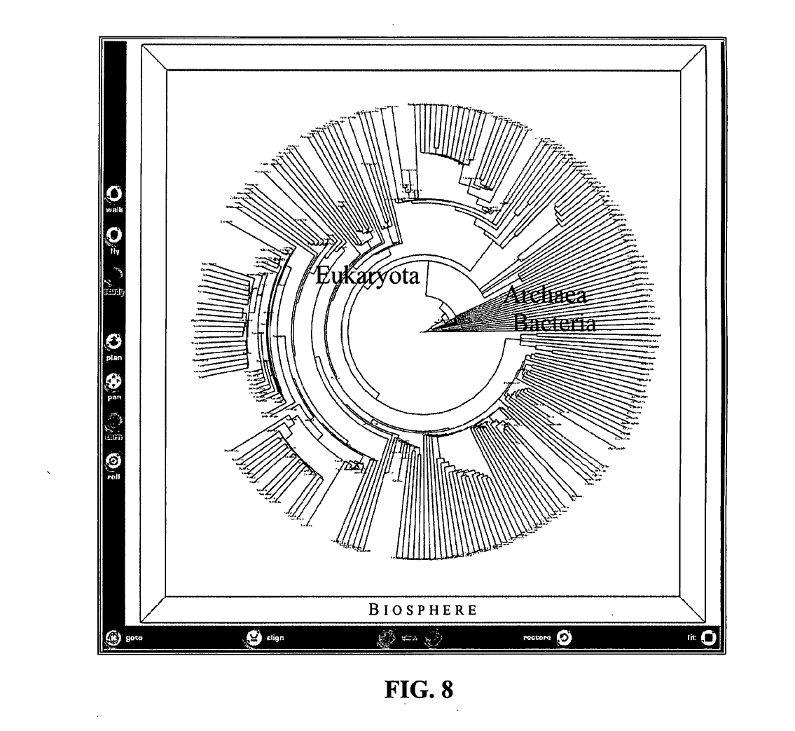

FIG. 8 is a screen shot of the overhead isolated view of the Biosphere tree.

Likewise, the same is true for the METACLUSTER schematic at 6 (FIG. 1). Clicking on the METACLUSTER link gives an isolated view of the circular schematic for the Metacluster in the schematic of FIG. 1, which is a simulated plot of galaxy clusters; each dot representing a galaxy cluster. Clicking on METACLUSTER will load a classification table to the right frame, 10, and a link therein will bring up the circular schematic.

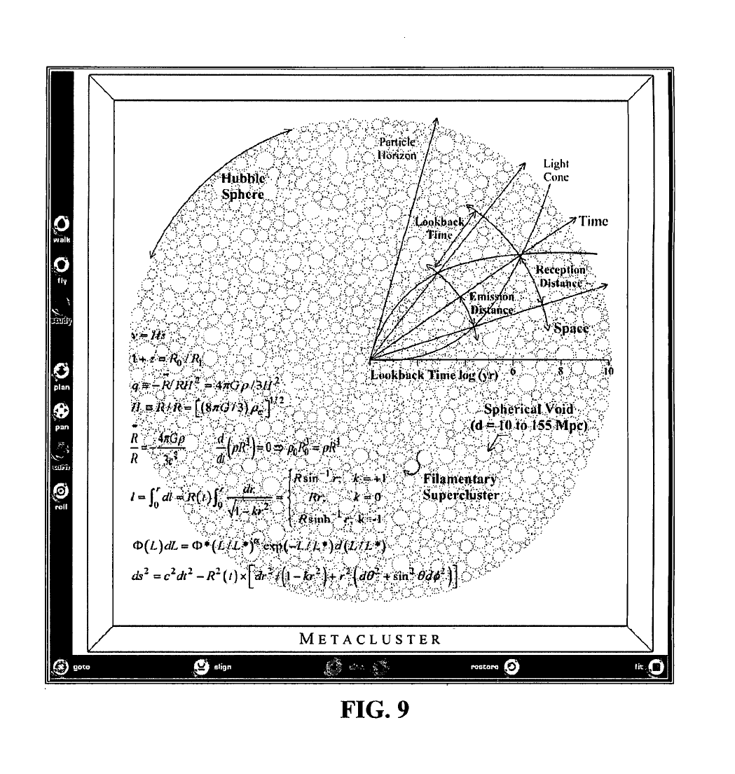

FIG. 9 is a screen shot of the overhead isolated view of the Metacluster map.

Each of the sub-topics listed under the main cosmological phenomena classifications 6 likewise provides a path to more detailed information, particularly in connection with the loading of classification tables as discussed above.

Additionally, clicking on, for example, “organelles” engenders a third frame displaying text, “Comments,” on organelles . . . “Discussions relating to the first metamolecular structures typically focus on protocells. However, it is seemingly more likely that these would have been more closely analogous to organelles. This is suggested primarily by the fact that it is too big a leap to go from the molecular to the cellular level. It is also suggested by biological theory that specifies cellular organization resulting from endosymbiotic assimilation of prokaryotes by eukaryotes”. There may be multiple levels of additional information.

It should now be apparent that the above-described software offers a three-dimensional interactive unified map of all the sciences (including civil, life, physical, biological, and astronomical sciences) and ensures more expedient (“drill-down”) access to detailed information. The software serves as a useful source for data, concepts and graphical illustrations of phenomena, and provides great benefit to scientists, students and anyone who would otherwise use an encyclopedia with its 2D static schematics.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

### INDUSTRIAL APPLICABILITY

Computers rely on graphical user interfaces (GUIs) which are usually two-dimensional, with visual elements lying in the xy plane. However, 2D GUIs can be confusing, especially when highly populated visual elements begin to overlap and obscure each other. This is the case with existing scientific reference software programs which tend to devote themselves to one particular branch of science, and use simple 2D “table-of-contents-like” user interfaces. Such software and interfaces are of limited value because they fail to show any relationships between the various scientific branches. 3D GUIs exist in which visual elements are situated in xyz space, defined in terms of 3D coordinates, which need not be flat and may contain spatial regions. A three-dimensional GUI is capable of communicating information more effectively than two-dimensional, but 3D GUIs have not been used for scientific reference software because of difficulties in mapping the various branches of science into a common xyz coordinate frame. Nevertheless, there is significant industrial applicability in doing this in order to visually convey the interrelationships between the numerous and varied scientific branches of study, and to provide a more unified interface with which to access more detailed information. The present invention accomplishes the foregoing with a three-dimensional mapping software method that maps all science and humanities concepts for our cosmos into a single 3D time/space coordinate system, thereby provising a GUI suitable for use as an overarching scientific reference. The software satisfies industrial demand by serving as a useful source for data, concepts and graphical illustrations of most all phenomena, and is helpful to professionals in the sciences, students and anyone who would otherwise use a scientific reference or encyclopedia.

What is claimed is:

1. A computer program recorded on a hard disk for generating a display of a graphical user interface comprising
a unified schematic composed of a singular graph representing a composite of individual diagrams each corresponding to a primary phenomena studied in a science and humanities discipline, said unified schematic appearing as a defined shape in an exponential time and space coordinate system, whereby a user can access multiple inter-related points of information within an area of study via said graphical user interface.

2. The computer program for generating a display of a graphical user interface of claim 1 wherein said defined shape emulates a flower in a vase on a pedestal.

3. The computer program for generating a display of a graphical user interface of claim 1 wherein said defined shape emulates a lamp on a pedestal.

4. The computer program for generating a display of a graphical user interface of claim 1 wherein said defined shape emulates a tree on a plain.

5. A computer-based graphical user interface for organizing, linking, retrieving and displaying multiple inter-related points of information within an area of study comprising:
a first categorical listing of disciplines of study each including a hyperlink to additional informational content related to said disciplines;
a second categorical listing of primary phenomena studied in each of the first categorical disciplines each including a hyperlink to a related classification table; and
a unified schematic comprising a singular graph representing a composite of individual diagrams corresponding to each of said primary phenomena and plotted in a time and space coordinate system.

6. The computer-based graphical user interface of claim 5 wherein any of said individual diagrams can be retrieved and displayed in an enlarged isolated format by clicking on links in said related classification table.

7. The graphical user interface of claim 5 wherein said time-space coordinate system includes a vertical time axis, a primary horizontal space axis and a secondary horizontal space axis.

8. The graphical user interface of claim 7 wherein said vertical time axis is provided on a logarithmic scale.

9. The graphical user interface of claim 7 wherein the vertical time axis of said unified schematic diagram can be toggled between plotting years after the big bang and years before the present time.

10. The graphical user interface of claim 9 wherein said categorical listing of disciplines of study comprises a categorical listing of primary science and humanities disciplines.

11. The graphical user interface of claim 10 wherein said categorical listing of primary science and humanities disciplines comprises main categories of physical sciences, life sciences or civil sciences, and sub-categories therein.

12. The graphical user interface of claim 11 wherein said subcategories include cosmological phenomena each corresponding to one of the main categories of physical sciences, life sciences or civil sciences.

13. The graphical user interface of claim 10 wherein said second categorical listing of primary phenomena comprises main categories of civilization, the biosphere or the metacluster.

14. The graphical user interface of claim 8 wherein an equation for plotting said unified schematic within said time/space coordinate system along said vertical time axis scale is
N=(8.047×10⁻³−8.029×10⁻⁴T)^{-0.2809}+10.1783 exp [−2554.47(10−T)^{0.484597}]−0.7505
where N is the event number and T is the logarithm for years since the big bang.

15. The graphical user interface of claim 8 wherein the equation for plotting said unified schematic within said time/space coordinate system along said vertical time axis scale is
$$N = {\{ 8.047 \times {10}^{- 3} - 8.029 \times {10}^{- 4} [ \frac{ln ( {10}^{10} - {10}^{{T}_{ya}} )}{ln 10} ] \}}^{- 0.2809} + 10.1783 exp \{ - 2554.47 {( 10 - [ \frac{ln ( {10}^{10} - {10}^{{T}_{ya}} )}{ln 10} ] )}^{0.484597} \} - 0.7505$$
where N is the event number and T_{ya} is the logarithm for years ago.

16. The graphical user interface of claim 7 wherein said unified schematic can be rotated in three dimensions.

17. A computer-based graphical user interface for organizing, linking, retrieving and displaying multiple inter-related points of information within an area of study comprising:
a first viewer pane;
a main display pane, said main display pain further comprising,
a time/space coordinate system,
a categorical listing of disciplines of study each including a hyperlink to a list of sub-disciplines thereto in said primary viewer pane, said list of sub-disciplines providing by hyperlinks therein concept presentations related to said sub-discipline,
a categorical listing of studied phenomena corresponding to said categorical listing of disciplines of study, each studied phenomena including a hyperlink to more detailed concept presentations thereon in said primary viewer pane,
a unified schematic of said area of study comprising a chronological plot of individual diagrams of said studied phenomena within said time/space coordinate system whereby any of said individual diagrams of said inter-related points of information can be displayed in an enlarged isolated format by clicking on said categorical concept presentations; and
a plurality of controls for manipulating said schematic diagrams in three-dimensional space.

18. The graphical user interface of claim 17 further comprising a secondary viewer pane wherein detailed explanatory and supporting information and links to relevant data are displayed.

19. The graphical user interface of claim 18 wherein said plurality of controls includes Plan, Pan, Turn, Roll, GoTo, Align, View, Restore and Fit control buttons.

20. The graphical user interface of claim 18 wherein said time-space coordinate system is a representation of a three dimensional box having a vertical time axis, a primary horizontal space axis and a secondary horizontal space axis.

21. The graphical user interface of claim 20 wherein said plurality of controls can be used to rotate said box in 3 dimensions to present each of the six faces of the box and information displayed thereon to a viewer.

22. The graphical user interface of claim 21 wherein said vertical time axis is provided on a logarithmic scale.

23. The graphical user interface of claim 22 wherein said chronological plot of individual diagrams of said studied phenomena along said vertical time axis can be toggled between plotting years after the big bang and years before the present time.

24. The graphical user interface of claim 17 wherein said categorical listing of disciplines of study is a listing of primary science and humanities disciplines.

25. The graphical user interface of claim 24 wherein said categorical listing of disciplines of study are further categorized as within the physical sciences, life sciences or civil sciences.

26. The graphical user interface of claim 25 wherein said a categorical listing of studied phenomena is a listing of cosmological phenomena each corresponding to one of the primary science and humanities disciplines.

27. The graphical user interface of claim 26 wherein said categorical listing of studied phenomena are further categorized as pertaining to civilization, the biosphere or the metacluster.

28. The graphical user interface of claim 27 wherein said individual diagrams of said inter-related points of information are plotted within said time/space coordinate system along said vertical time axis pursuant to the following equation:
N=(8.047×10⁻³−8.029×10⁻⁴T)^{-0.2809}+10.1783 exp [−2554.47(10−T)^{0.484597}]−0.7505
where N is the event number and T is the logarithm for years since the big bang.

29. The graphical user interface of claim 28 wherein said individual diagrams of said inter-related points of information are plotted within said time/space coordinate system along said vertical time axis pursuant to the following equation:
$$N = {\{ 8.047 \times {10}^{- 3} - 8.029 \times {10}^{- 4} [ \frac{ln ( {10}^{10} - {10}^{{T}_{ya}} )}{ln 10} ] \}}^{- 0.2809} + 10.1783 exp \{ - 2554.47 {( 10 - [ \frac{ln ( {10}^{10} - {10}^{{T}_{ya}} )}{ln 10} ] )}^{0.484597} \} - 0.7505$$
where N is the event number and T_{ya} is the logarithm for years ago.
